(19) United States
(12) Patent Application Publication
(10) Pub. No.: US 2018/0019472 A1
(43) Pub. Date: Jan. 18, 2018

(54) METHOD FOR MANUFACTURING GRAPHITE POWDER FOR NEGATIVE-ELECTRODE MATERIAL FOR LITHIUM-ION SECONDARY BATTERY, NEGATIVE ELECTRODE FOR LITHIUM-ION SECONDARY BATTERY, AND LITHIUM-ION SECONDARY BATTERY

(71) Applicant: SHOWA DENKO K.K., Tokyo (JP)

(72) Inventors: Ayaka IKADO, Tokyo (JP); Yasuaki WAKIZAKA, Tokyo (JP); Takashi TERASHIMA, Tokyo (JP); Yoshikuni SATO, Tokyo (JP)

(73) Assignee: SHOWA DENKO K.K., Tokyo (JP)

(21) Appl. No.: 15/545,850

(22) PCT Filed: Jan. 26, 2016
(86) PCT No.: PCT/JP2016/052063

§ 371 Date: Jul. 24, 2017

(30) Foreign Application Priority Data
Jan. 27, 2015 (JP) 2015-013313

(51) Int. Cl. H01M 4/587; H01M 4/583

(52) U.S. Cl. CPC H01M 4/587; C01B 32/20; H01M 4/5835; C01B 2204/04

(57) ABSTRACT

A method for manufacturing a graphite powder for a negative electrode material for a lithium-ion secondary battery, which includes a process of pulverizing a graphite precursor, and subjecting a mixture of the pulverized graphite precursor and an alkaline compound to graphitization treatment by heating the mixture at 2,800 to 3,500° C. Also disclosed is a graphite powder obtained by the manufacturing method, a negative electrode for a lithium-ion secondary battery containing the graphite powder and a lithium-ion battery provided with the negative electrode.

### TECHNICAL FIELD

The present invention relates to a graphite powder, a negative electrode material for a lithium-ion secondary battery, a negative electrode for a lithium-ion secondary battery, and a lithium-ion secondary battery comprising the same. Specifically, the present invention relates to a graphite powder and a negative electrode material for a battery, which are suitable as an electrode material for a lithium-ion secondary battery; and a lithium-ion secondary battery using the negative electrode material, which has a high capacity, excellent charge/discharge characteristics, and a low electrode swelling rate in charge and discharge cycles.

### BACKGROUND ART

As a power source of a mobile device, or the like, a lithium ion secondary battery is mainly used. In recent years, the function of the mobile device or the like is diversified, resulting in increasing in power consumption thereof. Therefore, a lithium ion secondary battery is required to have an increased battery capacity and, simultaneously, to have an enhanced charge/discharge cycle characteristic.

Further, there is an increasing demand for a secondary battery with a high power and a large capacity for electric tools such as an electric drill and a hybrid automobile. In this field, conventionally, a lead secondary battery, a nickel-cadmium secondary battery, and a nickel-hydrogen secondary battery are mainly used. A small and light lithium ion secondary battery with high energy density is highly expected, and there is a demand for a lithium ion secondary battery excellent in large current load characteristics.

In particular, in applications for automobiles, such as battery electric vehicles (BEV) and hybrid electric vehicles (HEV), a long-term cycle characteristic over 10 years and a large current load characteristic for driving a high-power motor are mainly required, and a high volume energy density is also required for extending a cruising distance, which are severe as compared to mobile applications.

In the lithium ion secondary battery, generally, a lithium salt, such as lithium cobaltate, is used as a positive electrode active material, and a carbonaceous material, such as graphite, is used as a negative electrode active material.

Graphite is classified into natural graphite and artificial graphite. Among those, natural graphite is available at a low cost and has a high discharge capacity due to its high crystallinity. However, as natural graphite has a scale-like shape, if natural graphite is formed into a paste together with a binder and applied to a current collector, natural graphite is aligned in one direction. When a secondary battery provided with an electrode using natural graphite of high orientation property as a carbonaceous material is charged, the electrode expands only in one direction, which degrades the performance of the battery. The swelling of the electrode leads to the swelling of the battery, which may cause cracks in the negative electrode due to the swelling or may damage the substrates adjacent to the battery due to the detachment of a paste from the current collector. In order to prevent the damage accompanying the electrode swelling, there has been a demand for a carbonaceous material of low orientation property, which can be used for an electrode. Natural graphite, which has been granulated and formed into a spherical shape, is proposed, however, the spherodized natural graphite is crushed to be aligned by pressure applied in the course of electrode production. Further, as the spherodized natural graphite expands and contracts, the electrolyte intrudes inside the particles of the natural graphite to cause a side reaction. Therefore, the electrode material made of such natural graphite is inferior in cycle characteristics, and it is very difficult for the material to satisfy the requests such as a large current and an long-term cycle characteristic of a large battery. In order to solve those problems, Patent Document 1 and the like propose a method involving coating carbon on the surface of the natural graphite processed into a spherical shape. However, sufficient cycle characteristics have not been attained.

Regarding artificial graphite, there is exemplified a mesocarbon microsphere-graphitized article described in Patent Document 2 and the like. However, the article has a lower discharge capacity compared to a scale-like graphite and had a limited range of application. Further, it is difficult to achieve the cycle characteristic for a much longer period of time than the one for mobile applications, which is required for a large battery.

Artificial graphite typified by graphitized articles of petroleum, coal pitch, coke and the like is available at a relatively low cost. However, although a graphitized article of needle-shaped coke of high crystallinity shows a high discharge capacity, it is formed into a scale-like shape and is easy to be oriented in an electrode. In order to solve this problem, the method described in Patent Document 3 and the like yields results. The method according to Patent Document 3 can allow the use of not only fine powder of an artificial graphite material but also fine powder of a natural graphite, or the like, and exhibits very excellent performance for a negative electrode material for the mobile applications. However, its production method is cumbersome.

Further, negative electrode materials using so-called hard carbon and amorphous carbon described in Patent Document 4 are excellent in a characteristic with respect to a large current and also have a relatively satisfactory cycle characteristic. However, the volume energy density of the negative electrode material is too low and the price of the material is very expensive, and thus, such negative electrode materials are only used for some special large batteries.

Patent Document 5 discloses artificial graphite being excellent in cycle characteristics but there was room for improvement on the energy density per volume.

Patent Document 6 discloses an artificial graphite negative electrode produced from needle-shaped green coke. Although the electrode showed some improvement in an initial charge and discharge efficiency compared to an electrode of conventional artificial graphite, it was inferior in a discharge capacity compared to an electrode of a natural graphite material.

Patent Document 7 discloses an artificial graphite negative electrode produced from cokes coated with petroleum pitch in a liquid phase. In the negative electrode, the electrode capacity density has remained as an issue to be solved. Also, the production involves an operation of using large quantities of organic solvent and evaporating it, which makes the production method cumbersome.

Patent Document 8 discloses a method for obtaining a graphite powder by mixing coal tar pitch and a graphitization catalyst such as titanium oxide, and then via the processes of coking the mixture at a low temperature, carbonizing the mixture at a middle temperature, and graphitizing the mixture at a high temperature. The obtained graphite powder shows improvement an the discharge capacity and the initial charge-discharge efficiency. However, the method comprises a number of processes and the long-term usability of the graphite powder is not known due to the high content of the remaining metals in the powder.

### PRIOR ART

### Patent Documents

Patent Document 1: JP 3531391 B2 (U.S. Pat. No. 6,632,69)

Patent Document 2: JP 04-190535 A

Patent Document 3: JP 3361510 B2

Patent Document 4: JP 07-320740 A (U.S. Pat. No. 5,587,255)

Patent Document 5: WO 2011/049199 (U.S. Pat. No. 8,372,373)

Patent Document 6: JP 2001-023638 A

Patent Document 7: WO 2003/064560 (U.S. Pat. No. 7,323,120)

Patent Document 8: JP 2002-025556 A

### DISCLOSURE OF THE INVENTION

### Problems to be Solved by the Invention

Scale-like natural graphite, natural graphite formed into a spherical shape, and the natural graphite described in Patent Document 1 exhibit a high discharge capacity. However, it is very difficult for the materials to satisfy a long-term cycle characteristic required for a large battery.

On the other hand, it has been known that artificial graphite which is excellent in cycle characteristics can be produced by graphitizing a graphitizable material such as petroleum, coal pitch and coke. Among these, a graphitized article of needle shaped coke of high crystallinity shows a high discharge capacity, but it is formed into a scale-like shape and is easy to be oriented in an electrode. Therefore, it is difficult to achieve a high discharge capacity, a long-term cycle characteristic, and a low orientation property in an electrode at the same time.

### Means to Solve the Problem

The present invention comprises the constituents as described below.
[1] A method for manufacturing a graphite powder for a negative electrode material for a lithium-ion secondary battery, comprising a process of pulverizing a graphite precursor, and subjecting a mixture of the pulverized graphite precursor and an alkaline compound to graphitization treatment by heating the mixture at 2,800 to 3,500° C.
[2] The method for manufacturing a graphite powder for a negative electrode material for a lithium-ion secondary battery according to [1] above, wherein the alkaline compound is a hydroxide of alkali metal or alkali earth metal.
[3] The method for manufacturing a graphite powder for a negative electrode material for a lithium-ion secondary battery according to [2] above, wherein the hydroxide of alkali earth metal is calcium hydroxide.
[4] The method for manufacturing a graphite powder for a negative electrode material for a lithium-ion secondary battery according to any one of [1] to [3] above, wherein a ratio by mass of the graphite precursor to the alkaline compound is 70:30 to 97:3.
[5] The method for manufacturing a graphite powder for a negative electrode material for a lithium-ion secondary battery according to any one of [1] to [4] above, wherein the graphite precursor contains coke or coal.
[6] A graphite powder obtained by the production method according to any one of [1] to [5] above.
[7] The graphite powder according to [6] above, which substantially contains no metal element.
[8] A negative electrode for a lithium-ion secondary battery, which uses the graphite powder according to [6] or
[7] above as an active material.
[9] A lithium-ion secondary battery, which is provided with the negative electrode according to [8] above.
[10] A method for manufacturing a negative electrode for a lithium-ion secondary battery, comprising a process of obtaining a graphite powder for a negative electrode for a lithium-ion secondary battery by the method according to any one of [1] to [5] above, and a process of obtaining a negative electrode for a lithium-ion secondary battery by using the obtained graphite powder as an active material.
[11] A method for manufacturing a lithium-ion secondary battery, comprising a process of obtaining a graphite powder for a negative electrode for a lithium-ion secondary battery by the method according to any one of [1] to [5] above, a process of obtaining a negative electrode for a lithium-ion secondary battery by using the obtained graphite powder as an active material, and a process of using the obtained negative electrode as a negative electrode of a lithium-ion secondary battery.

### Effects of the Invention

Using the graphite powder of the present invention as a material for an electrode makes it possible to obtain a lithium-ion battery, having both of a high capacity and good cycle characteristics, and having a low electrode swelling rate in charge and discharge cycles; and a negative electrode for a lithium-ion battery and a negative electrode material having both of a high capacity and low orientation property to realize such a lithium-ion battery by a simple method.

### Embodiments for Carrying out the Invention

(1) Method for Producing a Graphite Powder for a Negative Electrode for a Lithium-Ion Secondary Battery

The method described below is suitable as a method for producing a graphite powder for a negative electrode for a lithium-ion secondary battery. There is no particular limitation for a graphite precursor to be used as a material for a graphite powder as long as it is a carbon material which can be graphitized by calcination. Coke or coal is preferable in terms of easiness in handling. A graphite precursor can be used singly, or two or more kinds thereof can be used in combination.

A green coke or a calcined coke can be used as a coke. As a raw material of the coke, for example, coal pitch, petroleum pitch, and a mixture thereof can be used. Particularly preferred is a calcined coke obtained by further heating the green coke under an inert atmosphere, wherein the green coke is obtained by the delayed coking treatment under specific conditions.

Examples of raw materials to be subjected to delayed coking treatment include decant oil which is obtained by removing a catalyst after the process of fluidized-bed catalytic cracking to heavy distillate at the time of crude oil refining, and tar obtained by distilling coal tar extracted from bituminous coal and the like at a temperature of 200° C. or more and heating it to 100° C. or more to impart sufficient flowability. It is desirable that the materials in the form of a liquid such as decant oil are heated to 450° C. or more, or even 510° C. or more, during the delayed coking treatment, at least at an inlet of the coking drum. By heating the materials to 450° C. or more, the residual carbon ratio of the coke at the time of calcination is increased. The calcination means performing heating to remove moisture and volatile organic components contained in the material such as green coke obtained by the delayed coking treatment. Also, pressure inside the drum is kept at preferably a normal pressure or higher, more preferably 300 kPa or higher, still more preferably 400 kPa or higher. Maintaining the pressure inside the drum at a normal pressure or higher, the capacity of a negative electrode is further increased. As described above, by performing coking under more severe conditions than usual, the reaction of the materials in the form of a liquid such as decant oil is further enhanced and coke having a higher degree of polymerization can be obtained.

The calcination can be performed by electric heating and flame heating using LPG, LNG, korocene, heavy oil and the like. Since the heating at 2,000° C. or less is sufficient to remove moisture and volatile organic components contained in the materials, flame heating as an inexpensive heat source is preferable for mass production. When the treatment is particularly performed on a large scale, energy cost can be reduced by an inner-flame or inner-heating type heating of coke while burning fuel and the organic compound contained in the unheated coke in a rotary kiln.

Coals are classified into anthracite, bituminous coal, subbituminous coal, and brown coal depending on the calorific value and the fuel ratio. There is no particular limitation for a coal to be used as a graphite precursor, but anthracite is suitable because it contains little volatile components and crystals easily develop in the coal. The mined coal is coarsely crushed and in some case dried. There is no particular limitation for the apparatus for crushing and drying. A double roll crusher, a jaw crusher or the like can be used as a crushing apparatus, and a rotary kiln or the like can be used as a drying apparatus.

Pulverization of the graphite precursor is conducted before the graphitization treatment. When the graphite precursor is large in size, it is desirable to roughly pulverize the graphite precursor to lumps about the size of 5 cm.

When coke as being a graphite precursor is obtained by the coking treatment, the obtained graphite precursor is to be cut out from the drum by water jetting, and roughly pulverized. A hammer, a double roll crusher and a jaw crusher can be used for the rough pulverization, and it is desirable to pulverize the graphite precursor so that when the aggregates after the pulverization are sift through a sieve with a mesh having a side length of 1 mm, and the aggregates remained on the sieve account for 90 mass % or more of the total aggregates. If the graphite precursor is pulverized too much to generate a large amount of fine powder having a diameter of 1 mm or less, problems such as the dust stirred up after drying and the increase in burnouts may arise in the subsequent processes such as heating.

The graphite precursor after being roughly pulverized is to be more finely pulverized. There is no limitation for the pulverization method and, it can be conducted using a known jet mill, hammer mill, roller mill, pin mill, vibration mill or the like.

It is desirable to perform pulverization so that coke has a median diameter in a volume-based cumulative particle size distribution by laser diffraction method, D₅₀, of from 1 μm to 50 μm. To perform pulverization to make D₅₀ less than 1 μm, it requires use of specific equipment and a large amount of energy. By setting D₅₀ to 50 μm or less, it accelerates the lithium ion diffusion in the electrode, thereby increasing the charge and discharge rate. D₅₀ is more preferably from 5 μm to 35 μm, still more preferably from 10 μm to 25 μm. Setting D₅₀ to 10 μm or more is more preferable because it is less likely to give rise to an unintended reaction. Considering that generation of a large current is required when the graphite powder is for use in the driving power source for automobiles and the like, D₅₀ is preferably 25 μm or less.

To produce a graphite powder in an embodiment of the present invention, the graphite precursor after being pulverized is further mixed with an alkali compound (a compound of alkali metal or alkali earth metal). Examples of the alkali metal include lithium, sodium, potassium, rubidium and cesium, and examples of alkali earth metal include magnesium, calcium, strontium and barium. Preferred is calcium. There is no particular limitation for a kind of the compound and examples thereof include an oxide, a hydroxide, a hydride and a carbide, and preferred is a hydroxide. As an alkali compound, preferred is calcium hydroxide. There is no particular limitation for a method of mixing, and examples include a method of dissolving an alkali compound in a solvent like water and alcohol, and spraying the resultant solution to the graphite precursor after being pulverized; and a method of simply mixing an alkali compound powder and the graphite precursor after being pulverized. An alkali compound becomes an impurity if it remains in a graphite powder, but there remains very little alkali compound because the compound evaporates with the high-temperature heating at the time of graphitization treatment.

Regarding the ratio by mass of the graphite precursor after being pulverized and an alkali compound to be mixed, if the ratio of the alkali compound is too low, the effect of promoting graphitization and the effect of alkali activation to be described later will be insufficient. If the ratio is too high, the amount of the graphite to be obtained becomes less as compared with the energy required for the graphitization. From the viewpoints described above, the ratio by mass of the graphite precursor and an alkali compound is preferably from 70:30 to 97:3, more preferably from 75:25 to 95:5, still more preferably from 80:20 to 90:10.

After mixing the graphite precursor after being pulverized and an alkali compound, and then the graphitization treatment is conducted. Graphitization is performed at a temperature of 2,800 to 3,500° C. or higher, more preferably 3,050 to 3,500° C. or higher, and still more preferably 3,150 to 3,500° C. The treatment time is, for example, from about 10 minutes to about 100 hours. The treatment at a higher temperature increases the degree of graphitization and further promotes the development of the graphite crystals, and an electrode having a higher storage capacity of lithium ion can be obtained. Also, it facilitates the removal of an alkali metal or an alkali earth metal from the mixture of the graphite precursor and an alkali compound. On the other hand, if the temperature is too high, it is difficult to prevent the sublimation of the graphite powder and an unduly large amount of energy for elevating the temperature is required. Therefore, the graphitization temperature is preferably 3,500° C. or lower. If the graphitization temperature is lower than 2,800° C., the degree of graphitization is low.

An alkali compound has a function of promoting graphitization (catalytic graphitization). For example, calcium oxide forms an unstable compound with carbon, and high crystallinity graphite is to be precipitated again. By the effect of the catalytic graphitization, the crystallinity of the graphite is improved and the discharge capacity is increased.

When the alkali compound to be used is a hydroxide, it is decomposed in the temperature elevation process and water is generated. For example, calcium hydroxide is thermally decomposed at 580° C. and generates water and calcium oxide. By using a method of performing graphitization treatment with steam (steam activation), carbon is oxidized by steam and pores are formed between the crystallites of a carbon material.

Further, in the alkali activation using an alkali compound for the activation of a carbide, an alkali vapor intrudes between the layers of graphite to thereby increase the space between the graphite layers and fine pores are formed between the crystallites of the carbon material. The effect of the alkali activation is enhanced when there are fine pores between the crystallites of the carbon material. By the formation of fine pores between the layers of the graphite, the thickness in a c-axis direction of crystallite, L_{c}, is decreased.

By the effect as described above, when the graphitization treatment is performed by mixing an alkali compound in a graphite precursor such as coke and coal, the thickness in a c-axis direction of cryatallite, L_{c}, is decreased. As a result, the orientation property of the graphite in an electrode is reduced and the cycle characteristics of a battery using the graphite as an active material can be improved. Particularly, a greater effect can be obtained by using a hydroxide of an alkali metal or an alkali earth metal is used as an alkali compound.

The graphitization treatment is conventionally carried out under atmosphere without containing oxygen, for example, in an environment filled with nitrogen gas or argon gas. In contrast, in the present invention, the graphitization treatment may be performed in an environment with a certain concentration of oxygen. Particularly when oxidation treatment is performed in an environment open to the atmosphere, it is desirable to design the furnace so that air flows into it during cooling the graphitizing furnace and the oxygen concentration in the furnace falls within 1 to 20%.

However, when the graphitization treatment is carried out under the condition that oxygen is contained in the reactor furnace, an impurity component derived from the mixed graphite precursor and the alkali compound is likely precipitate in the region being in contact with oxygen, and it is desirable to remove it. That is, the range from the portion in which the material is in contact with oxygen to a predetermined depth is removed, and the material underlying deeper than the predetermined depth is obtained as a graphite material. A determined depth is 2 cm, preferably 3 cm and more preferably 5 cm from the surface.

(2) Graphite Powder for a Negative Electrode Material for a Lithium-Ion Secondary Battery

The graphite powder for a negative electrode material for a lithium-ion secondary battery in an embodiment of the present invention has an average interplanar spacing of plane (002) by the powder X-ray diffraction method, d₀₀₂, of 0.33565 to 0.33580 nm and a thickness of a crystal in the direction of C-axis, Lc, of 90 nm or less, or has d₀₀₂ of 0.33540 to 0.33564 nm and Lc of 130 nm or less. In addition, it is preferable to adjust the intensity ratio of the peak intensity H₀₀₄ in a diffraction line derived from plane (004) to the peak intensity H₁₁₀ in a diffraction line derived from plane (110), H₀₀₄/H110, to 60 or less when the density of an electrode using the graphite powder in an embodiment of the present invention as an active material of a negative electrode is set to 1.3 to 1.5 g/cm³. H₀₀₄/H₁₁₀ an index of the orientation property, and the lower value indicates the lower orientation property of the active material in an electrode. H₀₀₄/H₁₁₀ is more preferably 10 or less.

d₀₀₂, Lc and H₀₀₄/H₁₁₀ can be measured using a powder X-ray diffraction (XRD) method by a known method (see I. Noda and M. Inagaki, Japan Society for the Promotion of Science, 117th Committee material, 117-71-A-1 (1263), M. Inagaki et al., Japan Society for the Promotion of Science, 117th committee material, 117-121-c-5 (1972), M. Inagaki, “Tanso”, 1963, No. 36, pages 25-34).

In an embodiment of the present invention, the BET specific surface area of the graphite powder for a negative electrode material for a lithium-ion secondary battery is preferably 0.4 m²/g to 15 m²/g, more preferably 1 m²/g to 11 m²/g. By setting the BET specific surface area to be within a range of 0.4 m²/g to 15 m²/g, a wide area to be contacted with an electrolytic solution can be secured without excessive use of a binder and lithium ions can be smoothly occluded and released, and the rapid charge and discharge characteristics can be improved with lowering the reaction resistance of the battery. The BET specific surface area is measured by a common method of measuring adsorption and desorption amount of gas per unit mass. As a measuring device, for example, NOVA-1200 manufactured by Yuasa Ionics can be used, and the BET specific surface area can be measured by nitrogen-gas molecule adsorption.

The graphite powder for a negative electrode material for a lithium-ion secondary battery in an embodiment of the present invention preferably has a median diameter in a volume-based cumulative particle size by laser diffraction method, D₅₀, of 5 μm to 35 μm. By setting D₅₀ to 35 μm, lithium ion diffusion in an electrode made from the powder is accelerated, resulting in the increase in the charging and discharging rate. The D₅₀ value is preferably 10 μm to 30 μm, more preferably 15 μm to 25 μm. Setting D₅₀ to 15 μm or more is more preferable because it prevents an unintended reaction. From the viewpoint that generation of a large current is necessary for the graphite powder to be used in the driving power source for automobiles and the like, D₅₀ is preferably 25 μm or less.

In the graphite powder for a negative electrode material for a lithium-ion secondary battery in an embodiment of the present invention, pores are generated and enlarged by steam activation or alkali activation. Therefore, the total pore volume measured by the nitrogen gas adsorption method with liquid nitrogen cooling is found to be 10.0 μl/g to 65.0 μl/g. When a graphite powder having a large volume of fine pores is used as a material for an electrode, the electrolytic solution is allowed to permeate the electrode easily and the rapid charge and discharge characteristics are improved at the same time. When the total pore volume is 10.0 μl/g or more, the negative electrode obtained from the graphite powder can attain a high initial charge-discharge efficiency, in which a side reaction is less likely to occur.

The graphite powder for a negative electrode material for a lithium-ion secondary battery in an embodiment of the present invention has a high discharge capacity. In a coin cell fabricated from a work electrode using the graphite powder as an active material, a lithium, metal counter electrode, a separator and an electrolytic solution; the discharge capacity per mass of the above mentioned active material in the initial cycle of the coin battery can be 350 mAh/g or more when the work electrode is produced by a method comprising a process of compressing the graphite powder under a predetermined pressure.

When the graphite powder for a negative electrode material for a lithium-ion secondary battery in an embodiment of the present invention is employed as an active material of the work electrode, and when the electrode is made by compressing the electrode material under a pressure of 3 t/cm², the electrode density of the work electrode is preferably 1.3 to 2.1 g/cm³, more preferably 1.5 to 2.1 g/cm².

It is desirable that the graphite powder for a negative electrode material for a lithium-ion secondary battery in an embodiment of the present invention does not substantially contain metal elements. Here, the state where the graphite powder does not substantially contain metal elements indicates that the content of each of the metal elements detected by the ICP optical emission spectrometry is less than 100 ppm by mass. If an impurity such as a metal element is contained in a negative electrode material, it causes increase in the electrical resistance and generates a side reaction. As a result, there is a risk of causing the deterioration of battery property and heat generation. Accordingly, the lower impurity concentration is the better in general, and the concentration is preferably 50 ppm by mass or less, more preferably 30 ppm by mass or less, still more preferably 20 ppm by mass or less.

The R value determined by laser Raman spectroscopy of the graphite powder for a negative electrode material for a lithium-ion secondary battery in an embodiment of the present invention is preferably 0.05 to 0.5, more preferably 0.05 to 0.15. By setting the R value within the range of from 0.05 to 0.5, lithium ions can be smoothly occluded and released. In addition, due to an ordered graphite structure inside the graphite powder, an amount of lithium ions to be occluded can be secured.

In the present specification, the R value means the intensity ratio ID/IG between the peak intensity ID in a range or 1300 to 1400 cm⁻¹ and the peak intensity IG in a range of 1580 to 1620 cm⁻¹ in the spectrum observed by laser Raman spectroscopy. The higher R value means a lower crystallinity.

The measurement of a spectrum is performed through use of, for example, a laser Raman spectrometer (NRS-3100) manufactured by JASCO Corporation under the conditions of an excitation wavelength of 532 nm, an entrance slit width of 200 μm, an exposure time period of 15 seconds, a number of times of integration of 2, and a number of diffraction grating lines per millimeter of 600. The R value can be calculated on the basis of a peak intensity around 1,360 cm⁻¹ and a peak intensity around 1,580 cm⁻¹ obtained by the measurement.

(3) Graphite Material for Electrodes

The graphite material for electrodes in an embodiment of the present invention contains the above-mentioned graphite powder. By using the graphite powder as a graphite material for an electrode, a battery electrode having a high energy density can be obtained, while maintaining a high capacity, a high coulomb efficiency and high cycle characteristics.

The graphite material for an electrode may be use for example, a negative electrode active material and an agent for imparting conductivity to a negative electrode of a lithium ion secondary battery.

The graphite material for electrodes in an embodiment of the present invention may comprise the above-mentioned graphite powder only. It is also possible to use the materials obtained by blending spherical natural graphite or artificial graphite having d₀₀₂ of 0.3370 nm or less in an amount of 0.01 to 200 parts by mass and preferably 0.01 to 100 parts by mass; or by blending natural or artificial graphite (for example, graphite having a scale-like shape) having d002 of 0.3370 nm or less and aspect ratio of 2 to 100 in an amount of 0.01 to 120 parts by mass and preferably 0.01 to 100 parts by mass based on 100 parts by mass of the above-mentioned graphite powder. By using the graphite material mixed with other graphite materials, the graphite material can be added with excellent properties of other graphite materials while maintaining the excellent characteristics of the graphite powder of the present invention. With respect to mixing of these materials, the material to be mixed can be selected and its mixing ratio can be determined appropriately depending on the required battery characteristics.

Carbon fiber may also be mixed with the graphite material for electrodes. The mixing amount is 0.01 to 20 parts by mass, preferably 0.5 to 5 parts by mass in terms of total 100 parts by mass of the above-mentioned graphite powder.

Examples of the carbon fiber include: organic-derived carbon fiber such as PAN-based carbon fiber, pitch-based carbon fiber, and rayon-based carbon fiber; and vapor-grown carbon fiber. Of those, in the case of allowing the carbon fiber to adhere to the surfaces of the graphite powder, particularly preferred is vapor-grown carbon fiber having high crystallinity and high heat conductivity.

Vapor-grown carbon fiber is, for example, produced by: using an organic compound as a raw material; introducing an organic transition metal compound as a catalyst into a high-temperature reaction furnace with a carrier gas to form fiber; and then conducting heat treatment (see, for example, JP 862-49363 and JP 2778434 B2). The vapor-grown carbon fiber has a fiber diameter of 2 to 1,000 nm, preferably 10 to 500 nm, and has an aspect ratio of preferably 10 to 15,000.

Examples of the organic compound serving as a raw material for carbon fiber include gas of toluene, benzene, naphthalene, ethylene, acetylene, ethane, natural gas, carbon monoxide or the like, and a mixture thereof. Of those, an aromatic hydrocarbon such as toluene or benzene is preferred.

The organic transition metal compound includes a transition metal serving as a catalyst. Examples of the transition metal include metals of Groups III to XI of the periodic table. Preferred examples of the organic transition metal compound include compounds such as ferrocene and nickelocene.

The carbon fiber may be obtained by pulverizing or disintegrating long fiber obtained by vapor deposition or the like. Further, the carbon fiber may be agglomerated in a flock-like manner.

Carbon fiber which has no pyrolysate derived from an organic compound or the like adhering to the surface thereof or carbon fiber which has a carbon structure with high crystallinity is preferred. The carbon fiber with no pyrolysate adhering thereto or the carbon fiber having a carbon structure with high crystallinity can be obtained, for example, by firing (heat-treating) carbon fiber, preferably, vapor-grown carbon fiber in an inactive gas atmosphere. Specifically, the carbon fiber with no pyrolysate adhering thereto is obtained by heat treatment in inactive gas such as argon at about 800° C. to 1,500° C. Further, the carbon fiber having a carbon structure with high crystallinity is obtained by heat treatment in inactive gas such as argon preferably at 2,000° C. or more, more preferably 2,000° C. to 3,000° C.

It is preferred that the carbon fiber contains a branched fiber. Further, in the branched portions, the carbon fiber may have hollow structures communicated with each other. In this case, carbon layers forming a cylindrical portion of the fiber are formed continuously. The hollow structure refers to a structure in which a carbon layer is wound in a cylindrical shape and includes an incomplete cylindrical structure, a structure having a partially cut part, two stacked carbon layers connected into one layer, and the like. Further, the cross-section is not limited to a complete circular shape, and the cross-section of the cylinder includes a near-oval or near-polygonal shape.

Further, the average interplanar spacing of a (002) plane by the X-ray diffraction method, d₀₀₂, is preferably 0.3440 nm or less, more preferably 0.3390 nm or less, particularly preferably 0.3380 nm or less. Further, it is preferred that a thickness in a c-axis direction of crystallite, Lc, is 40 nm or less.

When a graphite material for electrodes contain graphite or carbon fiber other than the above-mentioned graphite powder, it is desirable that the electrode density of the graphite material for electrodes, the metal contents measured by the ICP optical emission spectrometry, and the R value measured by the laser Raman spectrometry respectively fall within the ranges noted for the above-described graphite powder.

(4) Paste for Electrodes

The paste for an electrode in an embodiment of the present invention contains the above-mentioned graphite material for electrodes and a binder. The paste for an electrode can be obtained by kneading the graphite material for electrodes with a binder. A known device such as a ribbon mixer, a screw-type kneader, a Spartan granulator, a Loedige mixer, a planetary mixer, or a universal mixer may be used for kneading. The paste for an electrode may be formed into a sheet shape, a pellet shape, or the like.

Examples of the binder to be used for the paste for an electrode include known binders such as: fluorine-based polymers such as polyvinylidene fluoride and polytetrafluoroethylene; and rubber-based polymers such as styrene-butadiene rubber (SBR).

The appropriate use amount of the binder is 1 to 30 parts by mass in terms of 100 parts by mass of the graphite material for a battery electrode, and in particular, the use amount is preferably about 3 to 20 parts by mass.

A solvent can be used at a time of kneading. Examples of the solvent include known solvents suitable for the respective binders such as: toluene and N-methylpyrrolidone in the case of a fluorine-based polymer; water in the case of rubber-based polymers; dimethylformamide and 2-propanol in the case of the other binders. In the case of the binder using water as a solvent, it is preferred to use a thickener together. The amount of the solvent is adjusted so as to obtain a viscosity at which a paste can be applied to a current collector easily.

(5) Electrode

An electrode in an embodiment of the present invention comprises a formed body of the above-mentioned paste for an electrode. The electrode is obtained, for example, by applying the above-mentioned paste for an electrode to a current collector, followed by drying and pressure forming.

Examples of the current collector include metal foils and mesh of aluminum, nickel, copper, stainless steel and the like. The coating thickness of the paste is generally 50 to 200 μm. When the coating thickness becomes too large, a negative electrode may not be accommodated in a standardized battery container. There is no particular limitation for the paste coating method, and an example of the coating method includes a method involving coating with a doctor blade or a bar coater.

Examples of the pressure forming include roll pressurization, plate pressurization, and the like. The pressure for the pressure forming is preferably 0.5 to 5.0 t/cm², more preferably 1.0 to 4.0 t/cm², still more preferably 1.5 to 3.0 t/cm². As the electrode density of the electrode increases, the battery capacity per volume generally increases. However, if the electrode density is increased too much, the graphite material for electrodes is damaged and the cycle characteristic is generally degraded. The maximum value of the electrode density of the electrode obtained using the paste is generally 1.5 to 1.9 g/cm³. The electrode thus obtained is suitable for a negative electrode of a battery, in particular, a negative electrode of a secondary battery.

(6) Battery, Secondary Battery

The above-described electrode can be employed as an electrode in a battery or a secondary battery.

The battery or secondary battery in an embodiment of the present invention is described by taking a lithium ion secondary battery as a specific example. The lithium ion secondary battery has a structure in which a positive electrode and a negative electrode are soaked in an electrolytic solution or an electrolyte. As the negative electrode, the electrode in an embodiment of the present invention is used.

In the positive electrode of the lithium ion secondary battery, a transition metal oxide containing lithium is generally used as a positive electrode active material, and preferably, an oxide mainly containing lithium and at least one kind of transition metal element selected from the group consisting of Ti, V, Cr, Mn, Fe, Co, Ni, Mo, and W, which is a compound having a molar ratio of lithium to a transition metal element of 0.3 to 2.2, is used. More preferably, an oxide mainly containing lithium and at least one kind of transition metal element selected from the group consisting of V, Cr, Mn, Fe, Co and Ni.

It should be noted that Al, Ga, In, Sn, Pb, Sb, Bi, Si, P, B, and the like may be contained in a range of less than 30% by mole with respect to the mainly present transition metal. Of the above-mentioned positive electrode active materials, it is preferred that at least one kind of material having a spinel structure represented by a general formula LiₓMO₂ (M represents at least one kind of Co, Ni, Fe, and Mn, and x is 0.02 to 1.2), or Li_{y}N₂O₄ (N contains at least Mn, and y is 0.02 to 2) be used.

Further, as the positive electrode active material, there may be particularly preferably used at least one kind of materials each including Li_{y}MₐD₁₋ₐO₂ (M represents at least one kind of Co, Ni, Fe, and Mn, D represents at least one kind of Co, Ni, Fe, Mn, Al, Zn, Cu, Mo, Ag, W, Ga, In, Sn, Ph, Sb, Sr, B, and P with the proviso that the element corresponding to M being excluded, y=0 to 1.2, and a=0.5 to 1) or materials each having a spinel structure represented by Li_{z} (Mn_{b}E_{1-b})₂O₄ (E represents at least one kind of Co, Ni, Fe, Al, Zn, Cu, Mo, Ag, W, Ga, In, Sn, Ph, Sb, Sr, B and P, b=1 to 0.2, and z=0 to 2).

Specifically, there are exemplified LiₓCoO₂, LiₓNiO₂, LiₓFeO₂, LiₓMnO₂, LiₓCoₐNi₁₋ₐO₂, LiₓCo_{b}V_{1-b}O₂, LiₓCo_{b}Fe_{1-b}O₂, LiₓMn₂O₄, LiₓMn_{c}Co_{2-c}O₄, LiₓMn_{c}Ni_{2-c}O₄, LiₓMn_{c}V_{2-c}O₄, and LiₓMn_{c}Fe_{2-c}O₄ (where, x=0.02 to 1.2, a=0.l to 0.9, b=0.8 to 0.98, c=1.6 to 1.96, and z=2.01 to 2.3). As the more preferred transition metal oxide containing lithium, there are given LiₓCoO₂, LiₓNiO₂, LiₓFeO₂, LiₓMnO₂, LiₓCoₐNi₁₋ₐO₂, LiₓMn₂O₄, and LiₓCo_{b}V_{1-b}O_{z} (x=0.02 to 1.2, a=0.1 to 0.9, b=0.9 to 0.98, and z=2.01 to 2.3). It should be noted that the value of x is a value before starting charge and discharge, and the value increases and decreases in accordance with charge and discharge.

Although the median diameter in a volume-based cumulative particle size distribution, D₅₀, of the positive electrode active material is not particularly limited, the diameter is preferably 0.1 to 50 μm. It is preferred that the volume occupied by the particle group having D₅₀ of 0.5 to 30 μm be 95% or more of the total volume. It is more preferred that the volume occupied by the particle group having D₅₀ of 3 μm or less be 18% or less of the total volume, and the volume occupied by the particle group having D₅₀ of 15 μm to 25 μm be 18% or less of the total volume. D₅₀ can be measured using a laser diffraction particle size distribution analyzer, such as Mastersizer (registered trademark) produced by Malvern Instruments Ltd. as a laser diffraction type measurement device of particle size distribution.

Although the specific area of the positive electrode active material is not particularly limited, the area is preferably 0.01 to 50 m²/g, particularly preferably 0.2 m²/g to 1 m²/g by a BET method. Further, it is preferred that the pH of a supernatant obtained when 5 g of the positive electrode active material is dissolved in 100 ml of distilled water be 7 or more and 12 or less.

In a lithium ion secondary battery, a separator may be provided between a positive electrode and a negative electrode. Examples of the separator include non-woven fabric, cloth, and a microporous film each mainly containing polyolefin such as polyethylene and polypropylene, a combination thereof, and the like.

As an electrolytic solution and an electrolyte forming the lithium ion secondary battery in a preferred embodiment of the present invention, a known organic electrolytic solution, inorganic solid electrolyte, and polymer solid electrolyte may be used, but an organic electrolytic solution is preferred in terms of electric conductivity.

As an organic electrolytic solution, preferred is a solution of an organic solvent such as: an ether such as dioxolan, diethyl ether, dibutyl ether, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, diethylene glycol dimethyl ether, ethylene glycol phenyl ether, or diethoxyethane; an amide such as formamide, N-methylformamide, N,N-dimethylformamide, N-ethylformamide, N,N-diethylformamide, N-methylacetamide, N,N-dimethylacetamide, N-ethylacetamide, N,N-diethylacetamide, N, N-dimethylpropionamide, or hexamethylphosphorylamide; a sulfur-containing compound such as dimethylsulfoxide or sulfolane; a dialkyl ketone such as methyl ethyl ketone or methyl isobutyl ketone; a cyclic ether such as ethylene oxide, propylene oxide, tetrahydrofuran, 2-methoxytetrahydrofuran, 1,2-dimethoxyethane, or 1,3-dioxolan; a carbonate such as ethylene carbonate, butylene carbonate, diethyl carbonate, dimethyl carbonate, propylene carbonate, or vinylene carbonate; γ-butyrolactone; N-methylpyrrolidone; acetonitrile; nitromethane; or the like. There are more preferably exemplified: esters such as ethylene carbonate, butylene carbonate, diethyl carbonate, dimethyl carbonate, propylene carbonate, vinylene carbonate, or γ-butyrolactone; ethers such as dioxolan, diethyl ether, and diethoxyethane; dimethylsulfoxide; acetonitrile; tetrahydrofuran; or the like. A carbonate-based nonaqueous solvent such as ethylene carbonate or propylene carbonate may be particularly preferably used. One kind of those solvents may be used alone, or two or more kinds thereof may be used as a mixture.

A lithium salt is used for a solute (electrolyte) of each of those solvents. Examples of a generally known lithium salt include LiClO₄, LiBF₄, LiPF₆, LiAlCl₄, LiSbF₆, LiSCN, LiCl, LiCF₃SO₃, LiCF₃CO₂, LiN (CF₃SO₂)₂, and the like.

Examples of the polymer solid electrolyte include a polyethylene oxide derivative and a polymer containing the derivative, a polypropylene oxide derivative and a polymer containing the derivative, a phosphoric acid ester polymer, a polycarbonate derivative and a polymer containing the derivative, and the like.

It should be noted that there is no constraint for the selection of members required for the battery configuration other than the aforementioned members.

### EXAMPLES

Hereinafter, the present invention is described in more detail by way of typical examples. It should be noted that these examples are merely for illustrative purposes, and the present invention is not limited thereto.

It should be noted that, as for the graphite powder of Examples and Comparative Examples, an average interplanar spacing determined by an X-ray diffraction method, d₀₀₂, and a thickness of a crystal in the direction of C-axis, Lc, were measured by the above-described methods. Further, the methods for measuring other physical properties are given below.

(1) Measurement Method of the Median Diameter in a Volume-Based Cumulative Particle size Distribution D₅₀

The volume-based median diameter (D₅₀) was measured using laser diffraction particle size distribution analyzer, specifically, Mastersizer (registered trademark) produced by Malvern Instruments Ltd.

(2) Elemental Analysis Method

The kind and concentration of each element constituting the graphite powder were measured by using an ICP optical emission spectrometer (SPS3520UV) manufactured by Hitachi High-Technologies Corporation.

(3) Evaluation Using a Coin Cell

a) Production of Paste:

To 97 parts by mass of the graphite powder, an aqueous solution of 2 mass % of styrene butadiene rubber (SBR) and an aqueous solution of 2 mass % of carboxymethyl cellulose (CMC; produced by Daicel FineChem Ltd.) were added in an amount of 1.5 parts by mass, respectively. The mixture was kneaded by a planetary mixer to obtain a main undiluted solution.

b) Production of an Electrode:

Pure water was added to the main undiluted solution and the viscosity thereof is adjusted. After that, the resultant solution is applied to a high-purity copper foil. The foil is dried in vacuum at 120° C. for 1 hour to obtain an electrode material. The amount to be applied is adjusted so as to make the amount of the graphite powder be 5 mg/cm². The obtained electrode material is punched out into circular pieces and compressed under a pressure of about 3 t/cm² for 10 seconds to obtain an electrode.

c) Production of a Battery:

A coin cell is fabricated comprising the obtained electrode as a work electrode and lithium metal as a counter electrode, further comprising a polyethylene separator, electrolytic solution and a case in a dry argon atmosphere at a dew point of −80° C. or less. As an electrolytic solution, a mixed solution of 8 parts by mass of ethylene carbonate (EC) and 12 parts by mass of diethyl carbonate (DEC) is used, in which LiPF₆ is dissolved as an electrolyte so that the concentration is set to 1 mol/liter.

d) Charge and Discharge Test Using a Coin Cell:

The charge and discharge test of the above-mentioned work electrode is performed using the fabricated coin cell in a thermostatic bath set at 25° C.

First, after allowing a current of 0.050 to pass until the open-circuit voltage reached 0.002 V, the charging is kept at 0.002 V and stopped when a current value drops to 25.4 μA to measure the charging capacity of the work electrode. Next, current of 0.05C is allowed to pass until the open-circuit voltage reached 1.5 V to thereby measure the discharging capacity.

(4) Evaluation of Orientation Property

H₀₀₄/H₁₁₀ was calculated as an index of the orientation property of the active material in an electrode. First, an electrode material was obtained in the same way as that used for evaluation using a coin cell. The obtained electrode material is punched out into circular pieces and compressed under a pressure of about 3 t/cm² for 10 seconds, and was left to stand still at a normal temperature and pressure for three days. After being left to stand still, the density of the graphite powder in each electrode was measured. With respect to the electrodes having a density of 1.3 to 1.5 g/cm³, the ratio (H₀₀₄/H₁₁₀) between the peak intensity derived from plane (004) and the peak intensity derived from plane (110) in the diffraction line was calculated by the above-described X-ray diffraction method.

### Example 1

Calcined coal-based needle coke was pulverized with a bantam mill produced by Hosokawa Micron Corporation and subsequently coarse powder was excluded with a sieve having a mesh size of 32 μm. Next, the pulverized coke is subjected to air-flow classification with Turboclassifier (registered trademark) TC-15N produced by Nisshin Engineering Inc. to obtain powdery coke 1, substantially containing no particles each having a particle diameter of 1.0 μm or less. In the present invention, the state where the graphite powder substantially contains no particles having a diameter of 1.0 μm or less indicates that the particles having a particle diameter of 1.0 μm or less, which diameter is measured using Mastersizer (registered trademark) produced by Malvern Instruments Ltd., account for 0.1 mass % or less.

Powdery coke 1 and a calcium hydroxide powder (produced by Kanto Chemical Co., Inc.) were mixed at a ratio by mass of 80:20, and the mixture was subjected to graphitization treatment by heating under an argon atmosphere at 3,300° C. for one hour. The coarse powder was excluded from the obtained graphite powder with a sieve having a mesh size of 45 μm.

Table 1 shows, with regard to the obtained graphite powder, the median diameter in a volume-based cumulative particle size distribution D₅₀; the results of elemental analysis by ICP optical emission spectrometry; and the average interplanar spacing d₀₀₂, the thickness of a crystal in the direction of c-axis Lc, and H₀₀₄/H₁₁₀ which is an index of the orientation property calculated from the X-ray diffractometry. In addition, the discharge capacity of a coin battery fabricated by using the obtained graphite powder as an electrode, in which the compression pressure is 3 t/cm², was measured. The result is also shown in. Table 1.

### Example 2

Anthracite was pulverized with a bantam mill produced by Hosokawa Micron Corporation and subsequently coarse powder was excluded with a sieve having a mesh size of 32 μm. Next, the pulverized coke was subjected to air-flow classification with Turboclassifier (registered trademark) TC-15N produced by Nisshin Engineering Inc. to obtain powdery anthracite 1, substantially containing no particles each having a particle diameter of 1.0 μm or less. The obtained powdery anthracite 1 was calcined at a temperature of 1,300° C. to obtain calcined powdery anthracite 1.

The calcined powdery anthracite 1 and a calcium hydroxide powder (produced by Kanto Chemical Co., Inc.) were mixed at a ratio by mass of 80:20, and the mixture was subjected to graphitization treatment by heating under an argon atmosphere at 3,300° C. for one hour. The coarse powder was excluded from the obtained graphite powder with a sieve having a mesh size of 45 μm.

Table 1 shows the median diameter D₅₀, the results of elemental analysis by ICP optical emission spectrometry, and the calculated results of d₀₀₂, Lc and H₀₀₄/H₁₁₀. In addition, the discharge capacity of a coin battery fabricated by using the obtained graphite powder as an electrode was measured. The result is also shown in Table 1.

### Example 3

A graphite powder was obtained by the same method as in Example 2 except that the calcined powdery anthracite 1 and calcium hydroxide were mixed at a ratio by mass of 90:10.

Table 1 shows the median diameter D₅₀, the results of elemental analysis by ICP optical emission spectrometry, and the calculated results of d₀₀₂, Lc, and H₀₀₄/H₁₁₀. In addition, the discharge capacity of a coin battery fabricated by using the obtained graphite powder as an electrode was measured. The result is also shown in Table 1.

### Comparative Example 1

A graphite powder was obtained by the same method as in Example 1 except that only the powdery coke 1 obtained in Example 1 was subjected to graphitization treatment without the addition of calcium hydroxide.

Table 1 shows the median diameter D₅₀, the results of elemental analysis by ICP optical emission spectrometry, and the calculated results of d₀₀₂, Lc, and H₀₀₄/H₁₁₀. In addition, the discharge capacity of a coin battery fabricated by using the obtained graphite powder as an electrode was measured. The result is also shown in Table 1.

### Comparative Example 2

A graphite powder was obtained by the same method as in Example 2 except that only the calcined powdery anthracite 1 obtained in Example 2 was subjected to graphitization treatment without the addition of calcium hydroxide.

Table 1 shows the median diameter D₅₀, the results of elemental analysis by ICP optical emission spectrometry, and the calculated results of d₀₀₂, Lc, and H₀₀₄/H₁₁₀. In addition, the discharge capacity of a coin battery fabricated by using the obtained graphite powder as an electrode was measured. The result is also shown in Table 1.

### Comparative Example 3

A graphite powder was obtained by the same method as in Example 3 except that the graphitization treatment temperature was changed to 2,700° C.

Table 1 shows the median diameter D₅₀, the results of elemental analysis by ICP optical emission spectrometry, and the calculated results of d₀₀₂, Lc, and H₀₀₄/H₁₁₀. In addition, the discharge capacity of a coin battery fabricated by using the obtained graphite powder as an electrode was measured. The result is also shown in Table 1.

TABLE 1

| | | Ratio by | Graphi- | | | | | | | | | | Initial |
|---|---|---|---|---|---|---|---|---|---|---|---|---|---|
| | | mass (carbon | tization | | | | | ICP optical emission spectrometry | | | | | charge- |
| | | material:cal- | treatment | Median | XRD | | | Ca | Fe | Si | Ti | Al | discharge |
| | Carbon | cium hy- | temperature | diameter | d002 | Lc | H₀₀₄/ | (ppm by | (ppm by | (ppm by | (ppm by | (ppm by | capacity |
| | material | droxide) | (° C.) | D50 (μm) | (nm) | (nm) | H₁₁₀ | mass) | mass) | mass) | mass) | mass) | (mAh/g) |
| Example 1 | Coke | 80:20 | 3300 | 20.3 | 0.33562 | 126 | 49 | 20 | <5 | 10 | <5 | <5 | 360 |
| Example 2 | Anthracite | 80:20 | 3300 | 21.3 | 0.33570 | 88 | 5 | <20 | <5 | <10 | 10 | <5 | 361 |
| Example 3 | Anthracite | 90:10 | 3300 | 20.4 | 0.33579 | 80 | 6 | — | — | — | — | — | 354 |
| Comparative | Coke | 100:0 | 3300 | 20.7 | 0.33559 | 288 | 206 | 20 | <5 | <10 | — | — | 364 |
| Example 1 | | | | | | | | | | | | | |
| Comparative | Anthracite | 100:0 | 3300 | 21.8 | 0.33574 | 124 | 37 | <20 | <5 | <10 | 10 | <5 | 341 |
| Example 2 | | | | | | | | | | | | | |
| Comparative | Anthracite | 90:10 | 2700 | 19.4 | 0.33595 | 55 | 3 | — | — | — | — | — | 353 |
| Example 3 | | | | | | | | | | | | | |

Despite that the graphite powders for a negative electrode material manufactured by using a mixture of a carbon material and calcium hydroxide at the time of the graphitization treatment (Examples 1 to 3) has an average interplanar spacing d₀₀₂ equivalent to that of the graphite powders manufactured by subjecting a carbon material only to the graphitization treatment without the addition of calcium hydroxide (Comparative Examples 1 to 2), the thickness of a crystal in the direction of C-axis Lc is suppressed. Also, with regard to Example 1 to 3, the H₀₀₄/H₁₁₀ value as an index of orientation property is decreased and it suggests that the orientation property of the active material in the electrode is lowered. This is an effect of the steam activation and the alkali activation owing to the addition of calcium hydroxide at the time of graphitization treatment. From the fact that the orientation property is lowered by the effect of the foregoing activation, it is considered that, by using the graphite powder of the present invention for a negative electrode material, the electrode swelling at the time of charge and discharge can be suppressed to thereby improve the cycle characteristics.

In the case of using the anthracite as a carbon material and performing the graphitization treatment so that the maximum temperature might reach the same level (Examples 2 to 3 and Comparative Example 2), the improvement in the initial charge-discharge capacity is shown. Furthermore, from the fact that no difference can be found in the calcium element content in the graphite powders in the results of the ICP optical emission spectrometry, no influence due to the mixing of calcium hydroxide at the time of graphitization treatment is shown. It is considered to be due to the vaporization of calcium hydroxide by performing the graphitization treatment at a temperature as high as 3,300° C.

In contrast, even if the mixture of a carbon material and calcium hydroxide is used at the time of graphitization treatment, in the case where the maximum temperature is as low as 2,700° C. (Comparative Example 3), the average interplanar spacing d₀₀₂ becomes larger. It is considered that the low temperature in the graphitization treatment makes the graphitization difficult to proceed.

For these reasons, it is considered that when the graphite powder produced by the method of the present invention is used as an active material of electrodes, the orientation property of graphite in an electrode can be lowered, and as a result, the lithium-ion secondary battery using the graphite powder of the present invention has higher cycle characteristics compared to a battery using a conventional graphite powder.

### INDUSTRIAL APPLICABILITY

The lithium-ion secondary battery using the graphite powder for a negative electrode material of the present invention is small-sized and lightweight, and has a high discharge capacity and high cycle characteristics. Therefore, it can be suitably used for a wide range of products from mobile phones to electric tools, and even for a product that requires a high discharge capacity such as a hybrid automobile.

1. A method for manufacturing a graphite powder for a negative electrode material for a lithium-ion secondary battery, comprising a process of pulverizing a graphite precursor, and subjecting a mixture of the pulverized graphite precursor and an alkaline compound to graphitization treatment by heating the mixture at 2,800 to 3,500° C.

2. The method for manufacturing a graphite powder for a negative electrode material for a lithium-ion secondary battery according to claim 1, wherein the alkaline compound is a hydroxide of alkali metal or alkali earth metal.

3. The method for manufacturing a graphite powder for a negative electrode material for a lithium-ion secondary battery according to claim 2, wherein the hydroxide of alkali earth metal is calcium hydroxide.

4. The method for manufacturing a graphite powder for a negative electrode material for a lithium-ion secondary battery according to claim 1, wherein a ratio by mass of the graphite precursor to the alkaline compound is 70:30 to 97:3.

5. The method for manufacturing a graphite powder for a negative electrode material for a lithium-ion secondary battery according to claim 1, wherein the graphite precursor contains coke or coal.

6. A graphite powder obtained by the production method according to claim 1.

7. The graphite powder according to claim 6, which substantially contains no metal element.

8. A negative electrode for a lithium-ion secondary battery, which uses the graphite powder according to claim 6 as an active material.

9. A lithium-ion secondary battery, which is provided with the negative electrode according to claim 8.
